(19) United States
(12) Patent Application Publication
(10) Pub. No.: US 2026/0131521 A1
(43) Pub. Date: May 14, 2026

(54) APPARATUS AND METHOD FOR PRODUCING PLASTIC CONTAINERS WITH ASSIGNMENT OF PRODUCTION CAVITIES

(71) Applicant: KRONES AG, Neutraubling (DE)

(72) Inventor: Florian GELTINGER, Donaustauf (DE)

(21) Appl. No.: 19/384,219

(22) Filed: Nov. 10, 2025

(30) Foreign Application Priority Data
Nov. 8, 2024 (DE) 102024132670.0

(51) Int. Cl. B29C 49/78; B29C 49/06; B29L 31/00

(52) U.S. Cl. CPC B29C 49/78; B29C 49/06; B29C 2049/7875; B29C 2049/78755; B29L 2031/7158

(57) ABSTRACT

An apparatus for producing plastic containers, having a production device for producing plastic preforms, wherein this production device has a plurality of production cavities, and having a forming device which is configured for forming the plastic preforms produced by the production device into plastic containers, having a transport device which transports the plastic preforms produced by the production device to the forming device along a predetermined transport path, and having a heating device which heats the plastic preforms produced by the production device, wherein the apparatus has at least one first inspection device which is configured for detecting at least one physical property of a plastic preform produced by the production device, and further has a first assignment device which is configured for assigning to an inspected plastic preform the production cavity which produced this plastic preform.

### CROSS REFERENCE TO RELATED APPLICATION

This application claims benefit to German Patent Application Serial No. 10 2024 132 670.0, filed Nov. 8, 2024, the contents of which are incorporated herein by reference.

### BACKGROUND OF THE INVENTION

The present invention relates to an apparatus and a method for producing plastic containers. Such apparatuses and methods have long been known in the prior art. It is known, for example, that so-called plastic preforms are heated and, in this heated state, are formed into plastic bottles, in particular by (stretch) blow molding.

Apparatuses and methods for producing such plastic preforms are also known from the prior art, in particular in the form of so-called injection-molding machines.

More recently, efforts have also been made to combine such machines into complete systems. First, plastic preforms are produced, e.g., using an injection-molding machine, and these are then formed into containers and, in particular, plastic bottles.

It is also known that such apparatuses inspect certain properties of the plastic preforms. Using the data obtained during the inspection, it is possible, for example, to control and/or regulate the downstream forming machine, such as a blow-molding machine.

For example, online inspections downstream of an injection-molding machine or within a blow-molding machine are known. However, such procedures are complex, and no gaps can be closed.

EP 1 674 234 B1 discloses a method and an apparatus for handling ejected injection-molded parts. This involves determining from which mold cavity an inspected component was ejected.

EP 0 793 569 B1 describes a bottle inspection system along the transport path where the bottle is formed.

An optical inspection system for preforms is known from WO 2018/036857 A1. It is proposed that the preforms be in a relative position that is unchanged compared to an injection-molding process.

DE 10 2016 118 670 A1 describes a method and an apparatus for testing preforms. Thermal images of preforms are recorded using a thermal imaging camera during preform transfer.

A method and an apparatus for separating retained samples are known from DE 10 2009 011 269 B3. This separation is to take place away from a production machine.

WO 2018/051227 A1 describes an inspection apparatus for plastic preforms. DE 600 28 756 T2 describes a method and an apparatus for handling ejected injection-molded parts. Components to be ejected are kept in a selected order.

DE 10 2018 102 299 A1 describes a method and an arrangement for controlling at least one process parameter of an injection-molding machine. Image data of each injection-molded part conveyed to an inspection system are recorded.

The object of the present invention is therefore to improve such overall control of such machines.

### DETAILED DESCRIPTION OF THE INVENTION

An apparatus according to the invention for producing plastic containers, and in particular plastic bottles, has a production device for producing plastic preforms, wherein this production device has a plurality of production cavities, each of which is suitable and intended for forming individual plastic preforms.

Furthermore, the apparatus has a forming device which is suitable and intended for forming the plastic preforms produced by the production device into plastic containers, wherein this forming device has a plurality of forming stations, each of which is suitable and intended for forming plastic preforms into plastic containers.

Furthermore, the apparatus has a transport device which transports the plastic preforms produced by the production device to the forming device along a predetermined transport path.

This transport device preferably has several transport units, in particular adjoining transport units. Preferably, the transport device is suitable and intended for transporting the plastic preforms such that the order of the transported plastic preforms does not change.

Furthermore, a heating device is preferably provided which heats the plastic preforms produced by the production device, wherein this heating device is preferably arranged between the production device and the forming device. The applicant reserves the right to claim protection for an apparatus that does not have such a heating device.

According to the invention, the apparatus has at least one first inspection device which is suitable and intended for detecting at least one physical property of a plastic preform produced by the production device and for outputting at least one first value which is characteristic of this physical property.

In addition, the apparatus has at least one first assignment device which is suitable and intended for assigning to an inspected plastic preform the production cavity which produced this plastic preform. This assignment device is preferably suitable and intended for performing this assignment based upon a marking on the plastic preform.

Preferably, this assignment device is suitable and intended for assigning to several inspected plastic preforms, and preferably all inspected plastic preforms, the respective production cavity which produced the respective inspected plastic preforms.

The inspection device is preferably suitable and intended for inline inspection. Particularly preferably, the inspection device is suitable and intended for inspecting all the produced plastic preforms.

Advantageously, each production cavity is suitable and intended for providing the plastic preforms it has produced with a marking that is unique to this production cavity. For example, this marking can be applied to the individual plastic preforms in the manner of a stamping element. Particularly preferably, this is a marking that can be read by the identification device and in particular a visually perceptible marking.

In a further advantageous embodiment, the forming device is a blow-molding machine and in particular a stretch blow-molding machine. The blow-molding machine preferably has a movable and, in particular, rotatable carrier on which the forming stations are arranged.

This rotatable carrier is particularly preferably a so-called blowing wheel. Preferably, each forming station has a stretching rod, which can be inserted into the plastic preforms in order to stretch them in their longitudinal direction. Furthermore, each forming station preferably has an application device and in particular a blowing nozzle, which is preferably movable in a longitudinal direction of the plastic preforms and can be delivered to the plastic preforms in order to apply a flowable medium and in particular a gaseous medium and in particular blowing air to them.

In a further advantageous embodiment, the production device is an injection-molding machine.

In a further preferred embodiment, the heating device is an infrared oven. However, the use of a microwave oven would also be conceivable. Particularly preferably, this heating device has a transport device which is suitable and intended for transporting the plastic preforms, in particular individually and in a row.

Particularly preferably, the heating device has a rotating device, which rotates the plastic preforms relative to their longitudinal axis, in particular during heating. In this way, uniform heating of the plastic preforms can be achieved.

Particularly preferably, the heating device has a plurality of stationary heating elements which are arranged along the transport path of the plastic preforms and past which the plastic preforms are preferably transported during their heating.

In a further advantageous embodiment, the apparatus has a cooling device which is suitable and intended for cooling the produced plastic preforms and particularly preferably for cooling them at least in portions.

In a further advantageous embodiment, the apparatus has a sorting device which is suitable and intended for sorting the plastic preforms with regard to their orientation. This is preferably a sorting device having two spaced-apart and parallel rollers between which the plastic preforms can be transported.

In a further advantageous embodiment, the apparatus has a distance-generating device which generates distances and in particular equal distances between transported plastic preforms. This distance-generating device can, for example, be the so-called single-cycle starwheel, which generates the aforementioned distances between the transported plastic preforms.

In a preferred embodiment, the production device has a control device and in particular a regulating device, which is suitable and intended for controlling and, in particular, regulating the production device taking into account the first value.

It is possible to globally control or regulate parameters which are characteristic of the production of all plastic preforms, but it would also be possible to control and/or regulate specific cavities of the production device.

For example, temperatures, injection pressure, melting temperature, injection speed, holding pressure, and holding time and/or cooling time of individual cavities could be controlled individually.

In a preferred embodiment, the production of the plastic preforms in the individual production cavities is individually controllable.

In a further preferred embodiment, at least one parameter characteristic of the production of the plastic preforms in the production cavities is individually controllable for each production cavity. Preferably, at least two such parameters and preferably at least three such parameters are individually controllable for each production cavity.

It is already known in the prior art that a plurality of features relevant to the plastic preforms are inspected in the blow-molding machine and/or in the heating device. In the context of the invention, it is therefore proposed to assign these features to the respective production cavity in the injection mold tool through additional detection of the individual plastic preforms, i.e., plastic preform quality detection, in particular in the heating device.

Preferably, the process on the injection-molding machine can be controlled and, in particular, regulated via a closed-loop control system based upon the production quality and the feature statistics.

Particularly preferably, this regulation is carried out globally and/or individually, and preferably both globally and individually for the respective production cavity. As mentioned, parameters can be changed for all production cavities, but it would also be possible to change or adjust parameters for individual production cavities.

In a further preferred embodiment, the features explained in detail below are evaluated on a cavity-specific basis. Statistics on the individual cavity-specific values can also be output. This can particularly preferably be carried out on the HMI (human-machine interface) of the production device or injection-molding machine. It would also be possible to visualize the values, in particular in the vicinity of the production device or injection-molding machine.

In a further advantageous embodiment, a plastic preform-by-plastic preform inspection of the plastic preforms is provided, in particular an inline inspection. For example, it is possible to combine the aforementioned inspection with such an inline inspection of the plastic preforms-for example, at the outlet of the production device. In this way, additional features can be inspected, for example, by inspecting the bulk material (i.e., the plastic preforms) on a transport belt or during a transfer from one transport belt to the next, and integrated into the aforementioned regulation and evaluation.

In a further preferred embodiment, the first inspection device is arranged in a region of the heating device. A region of the heating device is understood to mean, in particular, the regions from a supply device, which supplies the plastic preforms to the actual heating device, to an end of a heating section.

For example, this first inspection device can be provided in the region of a supply starwheel and in particular a single-cycle starwheel, which separates the plastic preforms and thus supplies them in this separated state to the transport device of the heating device.

It would also be possible to arrange the first inspection device in a region in which the plastic preforms are heated-for example, along a linear transport path of the plastic preforms.

Preferably, the heating device has a circulating transport device. In particular, this is a circulating transport chain or a circulating transport belt on which a plurality of holding devices for holding the plastic preforms are arranged.

Particularly preferably, the heating device has a first heating section in which the plastic preforms are heated, and a second heating section in which the plastic preforms are also heated. Particularly preferably, a transition section is provided between the first heating section and the second heating section, in which the plastic preforms are not heated.

Preferably, the plastic preforms are transported in a straight line along at least one and preferably at least both heating sections. Particularly preferably, the transport device has a deflection region in which a direction of movement of the plastic preforms is reversed. For example, the transport device can have two transport wheels, which serve to deflect the transport means, such as a chain.

Particularly preferably, the first inspection device or at least one inspection device is arranged in a region of such a deflection. This has the advantage that, in these regions, the plastic preforms are at a greater distance from each other than in the straight transport sections. In addition, this also has the advantage that the plastic preforms in these regions are usually not rotated about their own axis or are rotated in a manner defined for the purpose of inspection, whereas, in the heating regions, they are also rotated about their own axis.

In the region of the heating sections (i.e., in particular before and after the deflection), the plastic preforms are preferably actively rotated. However, the rotation is adapted to the heating process and can be very slow (long distance for one rotation) or very fast.

In the deflection, the plastic preforms are preferably actively rotated about their own axis. The rotation preferably occurs independently of the heating process and is preferably reproducibly coordinated with the inspection so that the cameras can record an approximately 360° process.

Particularly preferably, the inspection device is an optical inspection device which is suitable and intended for recording a spatially resolved image of the plastic preforms and in particular of the plastic preforms transported by the transport device. This inspection device is preferably suitable and intended for recording at least one spatially resolved image of the transported plastic preforms during their movement.

Particularly preferably, the first inspection device is arranged at a predetermined position along the transport path of the plastic preforms. This position is advantageously selected from a group of positions that includes a supply device (or the region of a supply device) which supplies the plastic preforms to the heating device, a deflection section of the transport device in which a transport direction of the plastic preforms is reversed, and a supply device which supplies the plastic preforms to the forming device.

However, an inspection device which supplies the plastic preforms to the heating device can also be provided in the region of the transport device.

As mentioned, these positions are particularly suitable because, in these regions, the plastic preforms are at a defined and, in particular, equal distance from each other, so that individual plastic preforms can be identified. This also makes it possible to assign the inspection results of specific plastic preforms to the respective production cavity which produced this plastic preform.

In a further advantageous embodiment, the apparatus has a further inspection device for inspecting the plastic preforms, wherein this further inspection device is preferably arranged at an outlet of the production device. This makes it possible to check the production of the plastic preforms, in particular directly at the outlet of the production device and in particular of an injection-molding machine.

Preferably, this further inspection device can also be assigned to those production cavities which produced the corresponding inspected plastic preforms. This further inspection device can also check a spatially resolved image of all produced plastic preforms or of those plastic preforms which were produced in the same injection-molding process.

Preferably, the production device dispenses the plastic preforms in batches. This means that preferably all production cavities continuously produce plastic preforms, and these are each dispensed as part of a uniform batch.

In a further advantageous embodiment, the apparatus has a second inspection device which is suitable and intended for detecting at least one second physical property of a plastic preform produced by the production device and preferably for outputting a second value which is characteristic of this physical property. Particularly preferably, the first inspection device and the second inspection device are arranged at different positions along the transport path of the plastic preforms.

Particularly preferably, the apparatus has at least two inspection devices, preferably at least three inspection devices, and particularly preferably at least four inspection devices. Preferably, at least two of these inspection devices and preferably at least three of these inspection devices are arranged at different positions along the transport path of the plastic preforms.

Preferably, the plastic preforms are transported past several inspection devices or can be transported past them. Inspections can preferably be carried out for a specific plastic preform and preferably for several plastic preforms and particularly preferably for all plastic preforms with several sensor devices, and the corresponding measured values can be assigned to each other. This means that several parameters are recorded for each plastic preform. These can preferably also be assigned to each other.

Furthermore, for each plastic preform, the production cavity which produced this plastic preform can be determined.

Preferably, a value tuple of several values determined for this plastic preform can be determined for each plastic preform, and this can then be assigned to the production cavity which produced this plastic preform. Furthermore, the forming station which will form this plastic preform into a plastic container can also be determined.

Preferably, the apparatus has at least two inspection devices and in particular at least two inspection devices which inspect at least two different regions of the plastic preforms. Thus, one inspection device may be suitable and intended for inspecting a mouth region of the plastic preforms and the other inspection device may be suitable and intended for inspecting a main body of the plastic preforms or a lower dome region of the plastic preforms.

Particularly preferably, the respective second values can also be assigned to the production cavity which produced the corresponding plastic preform. As mentioned above, this assignment can be made, for example, by detecting a marking, such as a number, which is characteristic of a certain production quality.

To detect this number, an image recording device with at least two cameras is preferably provided, and preferably also an illumination device which illuminates the plastic preforms for the purpose of their inspection. Preferably, this image recording device is arranged in a deflection of the heating device. Particularly preferably, this image recording device is arranged above an inspection device which inspects a circumferential wall of the plastic preforms.

Particularly preferably, the production cavities produce plastic preforms which differ in at least one marking. Thus, each production quality can preferably assign a unique characteristic feature to each plastic preform it produces or mark the plastic preform accordingly. For example, the production device could have an array of production cavities, each of which is assigned specific numbers, which are also embossed into the plastic preform to be produced. Using this number or, in general, this marking, the production cavity can then be (unambiguously) identified.

Particularly preferably, the first and second results and/or measured values relating to the same plastic preform can also be assigned to each other.

Particularly preferably, the at least one first physical property and/or a second physical property of a plastic preform produced by the production device is selected from a group of properties which includes a property of a side wall of the plastic preform, such as in particular, but not exclusively, a thickness or transparency, a property of a mouth of the plastic preform such as in particular a property of a thread of the plastic preform or a property of a support ring of the plastic preform, a color of the plastic preform, an infrared absorption coefficient of a plastic preform, a temperature of the plastic preform(s), a moisture content of the plastic, a material stress, a property of a preform gate of the plastic preform, and the like.

The preform gate is a bottom inspection device or gate, in particular at the inlet of the blow-molding machine. This preferably involves inspecting the bottom of the plastic preform to ensure it is correctly positioned. This can be used to detect, for example, any wobbling of the preform body.

Preferably, several of these properties can be measured with one or more detection devices or inspection devices. In particular, several properties can be measured partially or completely at different positions of the transport path. Particularly preferably, these properties are measured at different positions (of the transport path of the plastic preforms).

For example, a property of a plastic preform can be determined at a preform gate, i.e., an inlet barrier. In addition, properties can also be measured at a furnace inlet.

In a further preferred embodiment, the apparatus may have a moisture measuring device which is suitable and intended for measuring a moisture content of the plastic preforms and/or the material of the plastic preforms. In a particularly preferred embodiment, this moisture measuring device is arranged in an inlet of the heating device and/or in a region upstream of the first heating section used to heat the plastic preforms. The measured values determined by this moisture measuring device can also be used to control the heating device, the forming device, and/or the production device (and/or the individual production cavities).

In a further preferred embodiment, a sensor device is provided which detects at least one measured value which is characteristic of the containers produced. For example, a wall thickness or a light transmission can be measured. The values determined by this sensor device can also be used to control and, in particular, regulate the individual forming stations and, in particular, the forming station which produced the plastic container in question.

This sensor device is preferably located in the region of an outlet starwheel that removes the formed containers from the forming device.

In addition, the apparatus preferably has a further inspection device which is suitable and intended for detecting defects in the plastic preforms, such as breakages, in particular in a bottom region of the plastic preforms. This further inspection device is preferably arranged in the region of a supply device which supplies the plastic preforms to the forming device.

Preferably, measured values of this further inspection device can also be used to control and, in particular, regulate the production cavity which produced the plastic preform in question and/or to control and/or regulate the production device as a whole.

Further properties, such as in particular the circumferential walls, can be measured, for example, in the deflection of the heating device as mentioned above. The cavity of the plastic preform or its interior in a furnace and in particular the furnace deflection can also be measured.

A further property and in particular properties of the mouths of the plastic preforms are preferably measured in a supply device-for example, an infeed starwheel to a blow-molding machine.

A further property which is characteristic of the plastic preforms can, for example, be properties of the bottom dome of the plastic preforms. These features can also be measured, for example, in a supply device such as an infeed starwheel of the forming device. Properties such as infrared absorption, color, and/or temperature can also be measured at different positions-for example, at the deflection regions of the heating device or the infeed starwheel.

Overall, this makes it possible to utilize the existing infrastructure in a blow-molding and/or injection-molding machine to inspect essential features and to achieve synergy effects by assembling or combining the two machines.

In a further advantageous embodiment, the apparatus has a second assignment device which assigns (or makes assignable) to an inspected plastic preform the forming station which forms or will form this plastic preform into a plastic container. In this way, individual control of the individual forming stations is also possible. For example, the forming process and in particular the stretch blow-molding process can be controlled individually for each plastic preform and in particular for each forming station based upon the measured values.

In a further preferred embodiment, certain measured values of the plastic preform, e.g., measured values which are characteristic of a wall thickness of the plastic preform, can also be transmitted to the production device and/or the individual production cavities, thus allowing regulation of the production device or the individual production cavities based upon this value, such as the wall thickness.

For example, characteristics of the forming process can be controlled which are selected from a group of characteristics or parameters which includes a blowing pressure, a stretch rod movement, different blowing pressure levels, switching between blowing pressure levels, an interaction of the application with pressure with the stretch rod movement, and the like. This is preferably possible individually for each individual plastic preform. During the inspection, it is preferably determined both which production cavity produced this plastic preform and which forming station will further process this plastic preform.

In a further preferred embodiment, the apparatus has at least two different inspection devices, which are suitable and intended for inspecting at least two different regions of the plastic preforms, in particular in the longitudinal direction of the plastic preforms, wherein these different regions are preferably selected from a group of regions which includes a mouth region of the plastic preforms, a main body of the plastic preforms, and a bottom region of the plastic preforms.

In a further preferred embodiment, the apparatus has at least one discharge device which is suitable and intended for discharging plastic preforms inspected by at least one inspection device from a transport path and in particular a transport path between the production device and the forming device. This discharge device is preferably arranged downstream of all inspection devices in the transport direction of the plastic preforms. The discharge device is preferably arranged downstream of the heating device in the transport direction of the plastic preforms.

The present invention is further directed to a method for producing plastic containers, wherein a production device produces plastic preforms, and wherein this production device has a plurality of production cavities, each of which forms individual plastic preforms, and wherein a forming device further forms the plastic preforms produced by the production device into plastic containers, wherein this forming device has a plurality of forming stations, each of which forms the plastic preforms into the plastic containers.

Furthermore, a transport device transports the plastic preforms produced by the production device to the forming device along a predetermined transport path, and a heating device heats the plastic preforms produced by the production device, wherein this heating device is arranged between the production device and the forming device.

According to the invention, the apparatus has at least one first inspection device which detects at least one physical property of a plastic preform produced by the production device and outputs at least one first value which is characteristic of this physical property, and, furthermore, the apparatus has an assignment device which assigns to an inspected plastic preform the production cavity which produced this plastic preform.

It is therefore also proposed in the context of the method according to the invention that the certain property of a plastic preform or of an inspected plastic preform be assigned to the production cavity which produced this plastic preform. In this way, as mentioned above, it is possible to control and/or regulate the production device and in particular the individual production cavities.

Particularly preferably, the production device is controlled and in particular regulated at least temporarily using the first value.

In a further preferred method, the forming device is controlled at least temporarily using the first value. Particularly preferably, an inspected plastic preform is assigned to the forming station which will form this plastic preform into a plastic container. Particularly preferably, independent control of the individual forming stations takes place in this way.

In a particularly preferred method, the apparatus has at least one second inspection device which detects at least one second physical property of a plastic preform produced by the production device and outputs at least one second value which is characteristic of this physical property.

Preferably, the first value is assigned to the second value. Particularly preferably, this second value is also assigned to a production cavity which produced the corresponding plastic preform.

### BRIEF DESCRIPTION OF THE DRAWINGS

Further advantages and embodiments emerge from the accompanying drawing: In the drawing:

FIG. 1 shows a schematic representation of a production apparatus according to the invention for producing plastic containers.

### DETAILED DESCRIPTION OF THE INVENTION

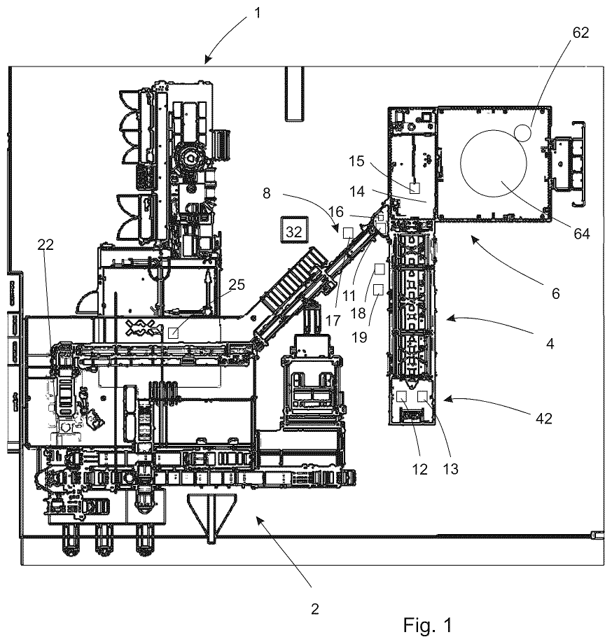

FIG. 1 shows a schematic representation of an apparatus for producing plastic containers and in particular plastic bottles. This apparatus has a production device 2 which produces plastic preforms. In particular, this is an injection-molding machine. Reference sign 22 schematically, and not in the correct position, outlines a production cavity used to produce a plastic preform.

A transport device, denoted as a whole by 8, transports the plastic preforms to or in the direction of a forming arrangement which has a heating device 4 for heating the plastic preforms, as well as a forming device 6 arranged downstream of this, which forms the plastic preforms into plastic containers and in particular plastic bottles.

The heating device has a transport device, in particular in the form of a circulating transport chain, on which a plurality of holding devices are arranged, each of which is suitable and intended for holding an individual plastic preform. These holding devices are preferably configured as holding mandrels that engage in the mouths of the plastic preforms.

Reference sign 42 denotes a deflection region of the transport device in which the transport direction of the plastic preforms is reversed.

Reference sign 64 denotes a transport device on which a plurality of forming stations 62 (only one shown) are arranged, each of which forms the plastic preforms into plastic containers.

Reference signs 11-19 indicate different inspection devices, each of which inspects the plastic preforms for different properties. The function of the individual inspection devices 11-19 is explained below.

Reference sign 11 denotes a first inspection device which is suitable and intended for inspecting a main body of the plastic preforms (preform gate). For example, an eccentricity of the plastic preform with respect to its rotational axis can be inspected. A curvature (in particular a banana shape) of the main body of the plastic preform can also be determined at least roughly.

Preferably, this first inspection device 11 is arranged in an inlet region of the heating device 4. This first inspection device or the values detected by this first inspection device can be used to control and/or regulate the production device.

In addition, the values measured by this inspection device 11 can also be used to eject defective plastic preforms, in particular before they reach the forming device.

Reference sign 12 denotes a second inspection device. This is preferably arranged in the deflection region 42 of the heating device. This second inspection device 12 is preferably used to inspect the main body of the plastic preforms.

For example, so-called black spots can be detected or, with greater accuracy, a curvature (banana profile) of the plastic preforms. It would also be conceivable to detect cracks, fractures, or bubbles in the main body. In addition, the length and/or shape of the plastic preform can also be detected.

Preferably, these data are also used to control the production device 2 and/or the forming device 6. It is preferably also possible to control and/or regulate individual production cavities 22 of the production device 2 based upon these measured values. These values are also used in particular to control and, in particular, regulate the entire system.

A third inspection device 13 serves to detect a marking on the individual plastic preforms which is characteristic of the production cavity 22 which produced this plastic preform. For example, a number of the production cavity can be detected using the inspection device 13.

Preferably, the third inspection device 13 is also arranged in the deflection region of the heating device 4. It would also be possible for the functions of the second inspection device and the third inspection device 13 to be combined in a common inspection device.

Reference sign 14 denotes a fourth inspection device which is suitable and intended for inspecting a mouth region of the plastic preforms. This fourth inspection device 14 can, for example, detect ovality of the plastic preforms or damage to their mouths.

In addition, this fourth inspection device 14 can also detect a value which is characteristic of an opacity of the plastic preforms or of contamination of these mouth regions.

Preferably, this fourth inspection device 14 is arranged in the region of a discharge device such as a discharge wheel, which discharges the heated plastic preforms from the heating device 4 and transports them to the forming device 6. The values determined by this fourth inspection device can be used to control the production device 2 and/or the forming device 6.

Reference sign 15 refers to a fifth inspection device, which preferably serves to inspect a bottom dome of the plastic preforms. This fifth inspection device 15 is preferably also arranged in the region of a discharge device such as a discharge wheel, which discharges the heated plastic preforms from the heating device 4 and transports them to the forming device 6.

Preferably, this fifth inspection device detects properties of the plastic preforms which are selected from a group of properties which detect an eccentricity of the plastic preforms, a gate (or a position and/or size of an injection point in order to check whether the injection point is located around the center), a curvature (in particular banana-like curvature), a color, and/or contamination.

These values can also be used to control the production device 2 and/or the individual production cavities.

The inspection devices 11-15 mentioned here serve in particular to regulate the production device 2 and/or the individual production cavities. Preferably, this inspection device is used to inspect all plastic preforms and in particular all transported plastic preforms. In particular, a regulation can also be carried out to correct detected defects or errors.

In addition, the measured values can also be used to control the individual forming stations.

Reference sign 16 denotes a sixth inspection device. This is preferably suitable and intended for inspecting the material of the plastic preforms. For example, water content or infrared absorption can be determined.

Preferably, this sixth inspection device is arranged in an inlet of the heating device 4. Preferably, values measured by this sixth inspection device 16 can also be used to control and, in particular, regulate the production device or also the individual production cavities 22.

Reference sign 17 denotes a seventh inspection device. This is preferably suitable and intended for inspecting the material of the plastic preforms. For example, a color or a color change (so-called yellowing) can be detected here. Preferably, this seventh inspection device is arranged in an inlet of the heating device 4.

Reference sign 18 denotes an eighth inspection device, here in the form of a temperature measuring device. This determines the temperature of the individual plastic preforms. Preferably, this eighth inspection device 18 is also arranged at an inlet of the heating device 4. The values measured by this eighth inspection device 18, and in particular temperature values, can also be used to control and, in particular, regulate the production device 2 and/or the individual production cavities.

The apparatus preferably has a further temperature measuring device (not shown), which is suitable and intended for detecting the temperature of the plastic preform after it has been heated by the heating device 4.

Preferably, the inspection devices 16-18 also serve to detect trends and changes in the measured values. In this way, it is possible to readjust the production device 2 and/or the individual production cavities.

Preferably, the said trends and changes can be detected for and/or assigned to each individual production cavity.

Reference sign 19 denotes a ninth inspection device, which is preferably suitable and intended for determining the temperatures of the individual main bodies or interiors of the individual plastic preforms. Preferably, this ninth inspection device is also arranged in a region of the inlet of the heating device 2.

Preferably, the measured values of this ninth inspection device can also be used to control and, in particular, regulate the production device and/or the individual production cavities.

Reference sign 25 denotes a further inspection device which is particularly suitable and intended for inspecting the plastic preforms produced directly by the production device and/or the individual production cavities. This further inspection device is also preferably suitable and intended for inline monitoring.

Preferably, this further inspection device inspects only a certain proportion of the plastic preforms produced, wherein this proportion is preferably between 20% and 90%, preferably between 30% and 90%, preferably between 40% and 85%, preferably between 50% and 85%, preferably between 60% and 80%, and particularly preferably between 70% and 80%. This additional inline monitoring achieves even faster feedback for the production process (of the plastic preforms).

Reference sign 32 denotes a first assignment device which is suitable and intended for assigning the values measured for certain plastic preforms by one or more inspection devices to the production cavity that produced the respective plastic preform. This assignment can be carried out, for example, with the aid of the marking on the individual plastic preforms detected by the third inspection device.

In a further advantageous embodiment, a temperature of the plastic preform can be detected, in particular in the region of an outlet of the heating device and/or after the heating section. In this case, a temperature measuring device is preferably provided which detects the temperature of the heated plastic preforms in a spatially resolved manner.

Preferably, the temperature can be detected at at least two different points in the longitudinal direction of the plastic preforms, preferably at at least three different points, preferably at at least four different points, preferably at at least six different points, preferably at at least ten different points, and preferably at at least 16 different points. In this way, a temperature profile of the individual plastic preforms can be created in their longitudinal direction. Preferably, the sensor device which detects this temperature profile is an IR camera.

It is to be noted that all features which have been described with reference to the method are also disclosed in a corresponding manner for the apparatus, which means in particular that the corresponding apparatus has devices which are suitable and intended for carrying out the particular methods. Furthermore, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

1. An apparatus for producing plastic containers, having a production device for producing plastic preforms, wherein this production device has a plurality of production cavities, each of which is configured for forming individual plastic preforms, and having a forming device which is configured for forming the plastic preforms produced by the production device into plastic containers, wherein this forming device has a plurality of forming stations, each of which is configured for forming plastic preforms into the plastic containers, having a transport device which transports the plastic preforms produced by the production device to the forming device along a predetermined transport path, and having a heating device which heats the plastic preforms produced by the production device, wherein this heating device is arranged between the production device and the forming device,
wherein
the apparatus has at least one first inspection device which is configured for detecting at least one physical property of a plastic preform produced by the production device and for outputting at least one first value which is characteristic of this physical property, and the apparatus further has a first assignment device which is configured for assigning to an inspected plastic preform the production cavity which produced this plastic preform.

2. The apparatus according to claim 1,
wherein
the production device has a control device which is configured for controlling the production device taking into account this first value.

3. The apparatus according to claim 1,
wherein
the production of the plastic preforms in the individual production cavities is individually controllable, and/or at least one parameter characteristic of the production of the plastic preforms in the production cavities is individually controllable for each production cavity.

4. The apparatus according to claim 1,
wherein
the first inspection device is arranged in the region of the heating device.

5. The apparatus according to claim 1,
wherein
the first inspection device is arranged at a predetermined position along the transport path of the plastic preforms, wherein this position is advantageously selected from a group of positions consisting of a supply device which supplies the plastic preforms to the heating device, a deflection wheel of the transport device which reverses a transport direction of the plastic preforms, and a supply device which supplies the plastic preforms to the forming device.

6. The apparatus according to claim 1,
wherein
the apparatus has a further inspection device configured for inspecting the plastic preforms.

7. The apparatus according to claim 1,
wherein
the apparatus has a second inspection device which is configured for detecting at least one physical property of a plastic preform produced by the production device and for outputting at least one first value which is characteristic of this physical property.

8. The apparatus according to claim 1,
wherein
the at least one physical property of a plastic preform produced by the production device is selected from a group of properties consisting of a side wall of the plastic preform, a property of a mouth of the plastic preform or a property of a support ring of the plastic preform, a color of the plastic preform, an infrared absorption coefficient of the plastic preform, a temperature of the plastic preform, and a property of a preform gate of the plastic preform.

9. The apparatus according to claim 7,
wherein
the at least one physical property of a plastic preform produced by the production device is selected from a group of properties consisting of a side wall of the plastic preform, a property of a mouth of the plastic preform or a property of a support ring of the plastic preform, a color of the plastic preform, an infrared absorption coefficient of the plastic preform, a temperature of the plastic preform, and a property of a preform gate of the plastic preform.

10. The apparatus according to claim 1,
wherein
the apparatus has a second assignment device which is configured to assign an inspected plastic preform to the forming station which forms this plastic preform into a plastic container.

11. The apparatus according to claim 1,
wherein
at least two different inspection devices are provided which are configured for inspecting at least two different regions of the plastic preforms.

12. The apparatus according to claim 1,
wherein
the apparatus has at least one discharge device which is configured for discharging plastic preforms inspected by at least one inspection device from a transport path.

13. A method for producing plastic containers, wherein a production device produces plastic preforms, wherein this production device has a plurality of production cavities, each of which molds individual plastic preforms, and wherein a forming device forms the plastic preforms produced by the production device into plastic containers, wherein this forming device has a plurality of forming stations, each of which forms the plastic preforms into the plastic containers, and wherein a transport device transports the plastic preforms produced by the production device to the forming device along a predetermined transport path, and a heating device heats the plastic preforms produced by the production device, wherein this heating device is arranged between the production device and the forming device,
wherein
the apparatus has at least one first inspection device which detects at least one physical property of a plastic preform produced by the production device and outputs at least one first value which is characteristic of this physical property, and the apparatus further has an assignment device which assigns to an inspected plastic preform the production cavity which produced this plastic preform.

14. The method according to claim 13,
wherein
the production device is controlled at least temporarily using the first value.

15. The method according to claim 13,
wherein
the forming device is controlled at least temporarily using the first value.

16. The method according to claim 13,
wherein
the apparatus has at least one second inspection device which detects at least one second physical property of a plastic preform produced by the production device and outputs at least one second value which is characteristic of this physical property.
